(19) United States
(12) Patent Application Publication
(10) Pub. No.: US 2015/0204495 A1
(43) Pub. Date: Jul. 23, 2015

(54) SOLAR-POWERED PURSE LIGHT

(71) Applicant: Marlee Schevers, Gulfport, MS (US)

(72) Inventor: Marlee Schevers, Gulfport, MS (US)

(21) Appl. No.: 14/594,887

(22) Filed: Jan. 12, 2015

Related U.S. Application Data
(60) Provisional application No. 61/930,622, filed on Jan. 23, 2014.

(51) Int. Cl. F21L 4/08; A45C 15/06; F21V 33/00

(52) U.S. Cl. CPC F21L 4/08; F21V 33/0008; A45C 15/06; F21Y 2101/02

(57) ABSTRACT

The present invention provides a solar-powered container, such as a purse, that is illuminated by a light source contained within its interior.

### CLAIM OF PRIORITY

The application is a non-provisional application and claims the benefit of the U.S. provisional patent application filed on Jan. 23, 2014 by Marlee Schevers for SOLAR-POWERED PURSE LIGHT (Ser. No. 61/930,622).

### FIELD OF THE INVENTION

The present invention relates generally to a solar-powered purse light for illuminating the interior of a handbag, purse, or other closeable/openable container.

### BACKGROUND OF THE INVENTION

It is often difficult to retrieve items from one's purse, handbag, or other container because of the lack of illumination inside the container. Various means have been developed to provide light to the interior of one's purse when retrieving items such as keys, lipstick, or other items. For example, it is known to employ a separate battery-powered light that may be attached by clipping to the inside of the purse. However, more economical and efficient means are needed.

The present invention provides a simple, but effective, means of illuminating the interior of a container such as a purse with a renewable energy source solar-powered light.

### BRIEF DESCRIPTION OF THE DRAWINGS

A full and enabling disclosure of the present invention, including the best mode thereof directed to one of ordinary skill in the art, is set forth in the specification, which makes reference to the appended drawings, in which:

FIG. 1 is a top plan view of the materials utilized by the inventor in forming the solar-powered purse of the present invention;

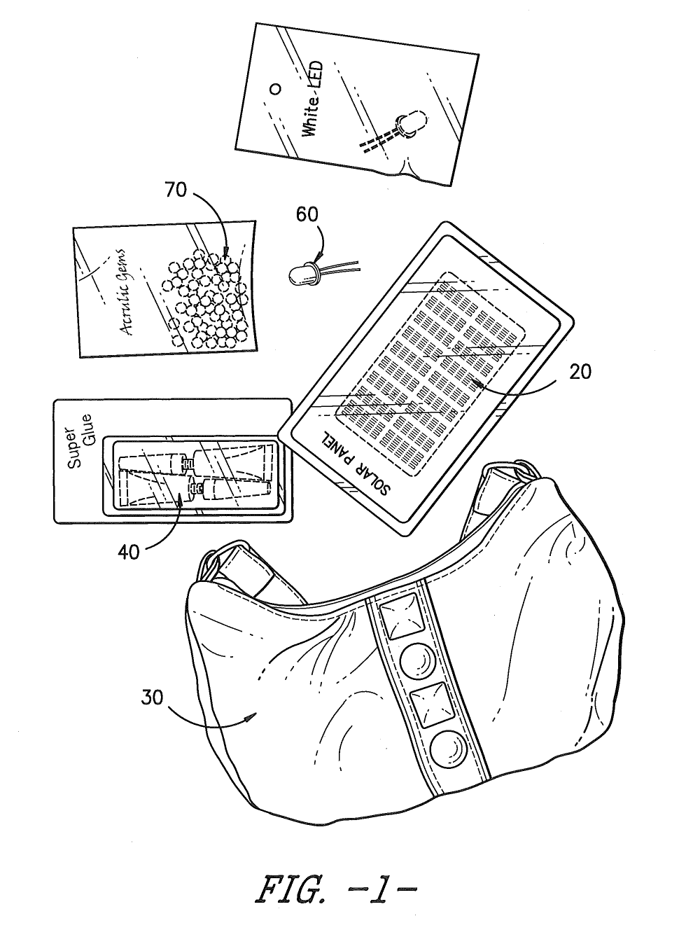

FIG. 2 is a plan view of the solar power panel connected to an LED light according to the present invention;

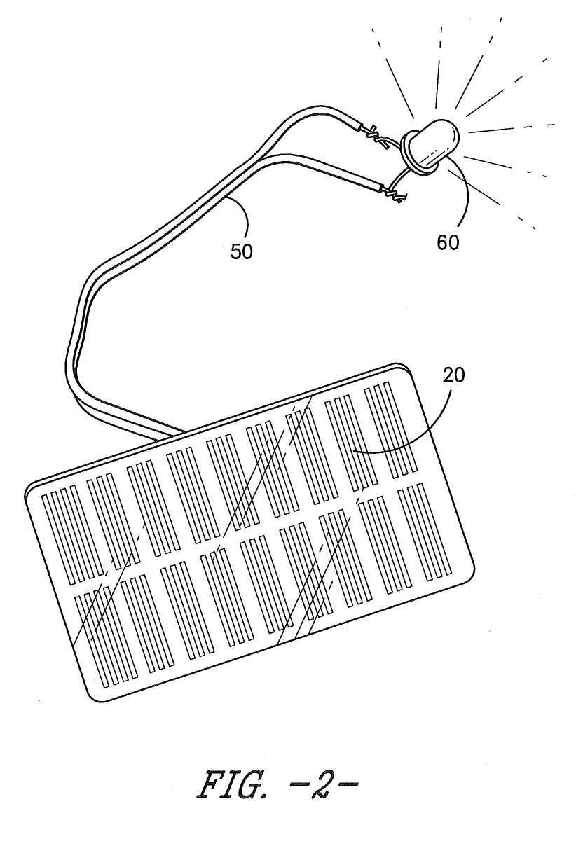

FIG. 3 is a side view of a purse having the solar panel of the present invention attached thereto; and

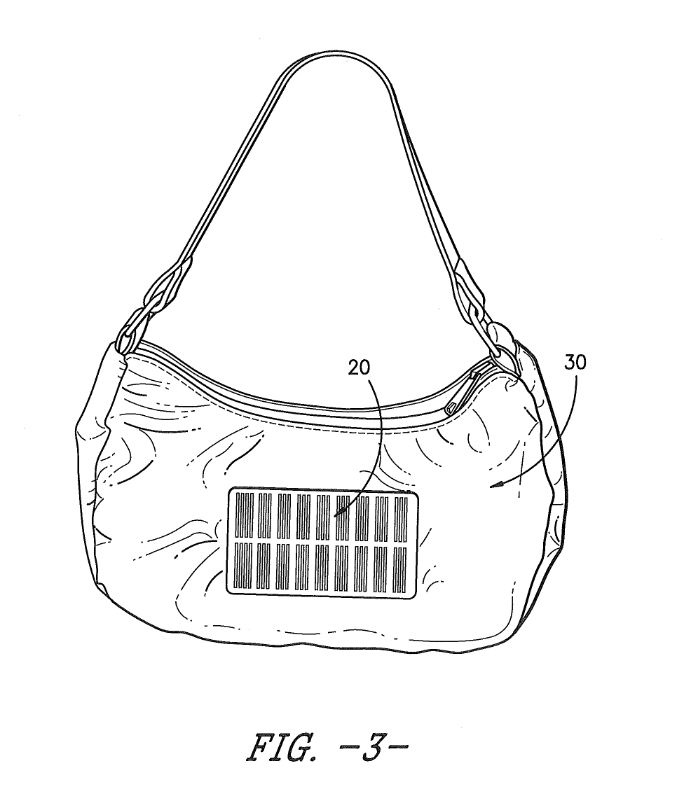

FIG. 4 is a top view showing the illumination of a purse in accordance with the present invention.

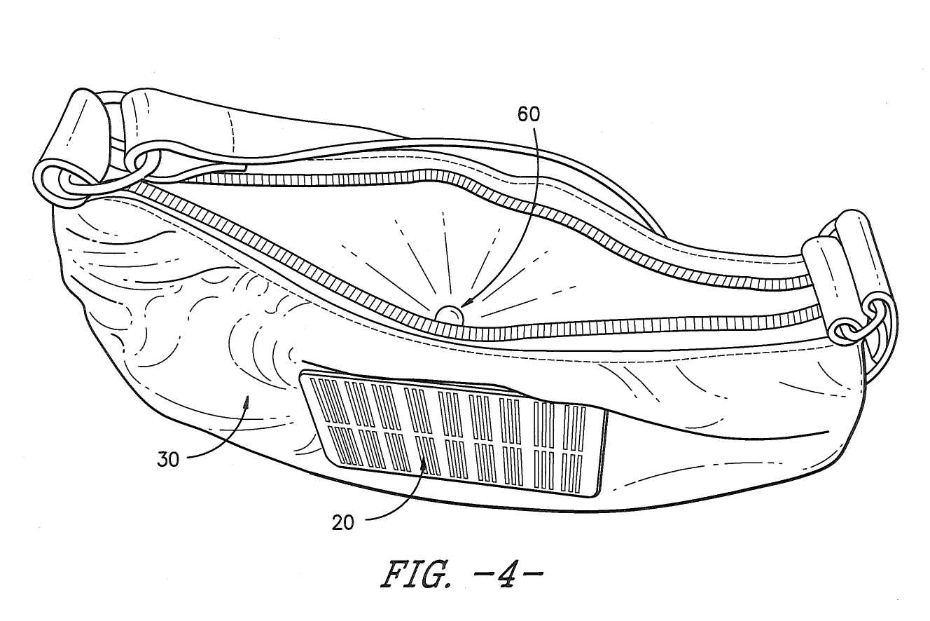

### DESCRIPTION OF INVENTION

Repeat use of reference characters in the present specification and drawings is intended to represent same or analogous features or elements of the invention.

According to an aspect, the present invention provides a solar-powered light for illuminating the interior of a container such as a purse. A solar power panel 20 of the type known in the art may be attached to the exterior of a purse 30. In certain embodiments, the solar panel may be formed integral with the purse construction and in others it may be attached by adhesive peel-n-strip means or by glue 40 as shown in the Figures. The solar power panel 20, once attached or mounted, is then connected by wires 50 to a light source, such as LED light 60. In final construction, the LED light 60 is placed or attached inside the interior of purse 30 and connected to the solar power panel 20 mounted on the exterior of purse 30.

Because it is solar powered, the light may remain on inside the purse at all times for illumination when the purse is opened or there may be an on/off mechanism. Such on/off mechanisms could be manually controlled or could be designed to turn on when the purse is opened or unzipped and then turn off when the purse is closed or zipped.

Other various embodiments may include one or more of the following improvements:

1) The use of decorative items such as gems 70 may be used to decorate the perimeter of the solar panel and/or purse;

2) The use of multiple LEDs and/or strips of LEDs in the interior of the purse;

3) The of color LEDs;

4) The use of LEDs that blink, stay on, or light on and off in a pattern;

5) The providing of solar power thin-film solar cells; peel-and-stick thin-film solar cells; and/or any combination of the aforementioned;

6) The use of solar panel(s), solar cells, or solar photovoltaic material(s) that are an intrinsic part of (in and of itself) the material from which the purse is constructed;

7) The use of solar photovoltaic power to charge lithium, lithium-derivative, or lithium-hybrid rechargeable battery(s) that will supply power to the LED(s) and other electronic devices carried in the purse such as phones, cameras, and the like;

8) The use of various activation devices to turn on and off the light source when the purse is opened (LED(s) turn on) or closed (LEDs) turn off); and

9) The use of internal docking station(s) for cell phone(s), computer tablets (iPad, Nook Book, Google Tablets, or any other tablets), computer laptop, other electronic devices to provide power directly through the solar photovoltaic means and/or through rechargeable lithium, lithium-derivative, or lithium-hybrid batteries.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged in whole or in part. Furthermore, those of ordinary skill in the art will appreciate that the foregoing description is by way of example only, and is not intended to limit the invention so further described in such appended claims. Therefore, the spirit and scope of the appended claims should not be limited to description of the version therein.

What is claimed is:

1. A solar-powered lighted container, comprising:
a closeable and openable container configured to house items and having an exterior and an interior;
a solar power energizer in communication with the exterior of the container;
a light source contained within the interior of the container; and
a connector connecting the solar power energizer to the light source that allows transfer of power to the light source that will allow the light source to illuminate the interior of the container.

2. The solar-powered lighted container of claim 1 wherein the container is a purse.

3. The solar-powered lighted container of claim 1 wherein the light source is an LED light.
